(19) United States
(12) Patent Application Publication
(10) Pub. No.: US 2005/0030690 A1
(43) Pub. Date: Feb. 10, 2005

(54) Spring clip, surge diverter with a spring slip and a surge diverter arrangement

(76) Inventors: Peter Bobert, Falkensee (DE); Frank Bother, Berlin (DE); Jurgen Boy, Berlin (DE); Norbert Krost, Berlin (DE)

Correspondence Address: FISH & RICHARDSON PC, 225 FRANKLIN ST, BOSTON, MA, 02110, US

(21) Appl. No.: 10/499,756

(22) PCT Filed: Dec. 16, 2002
(86) PCT No.: PCT/DE02/04596

(30) Foreign Application Priority Data
Dec. 20, 2001 (DE) 101 62 916.8

(51) Int. Cl. H02H 5/04

(52) U.S. Cl. 361/104

(57) ABSTRACT

The invention relates to a spring clip (17) having a clamping device (1) by means of which the spring clip (17) can be clamped from one side of a surge diverter (2) onto the latter, having at least one spring arm (3), having a thermal protective device (4) attached to the inside of the spring arm (3), and containing a fusible element (5). By attaching the thermal protective device (4) to the spring clip (17), a low melting temperature can be chosen for the fusible element (5). The invention also relates to a surge diverter array (2) with the spring clip (17). Furthermore, the invention relates to a method for manufacturing the array.

The invention relates to a spring clip for clamping onto a surge diverter. The invention also relates to a surge diverter array with the spring clip as well as a method for manufacturing the array.

Surge diverters of the type referred to in the introduction are known from U.S. Pat. No. 5,388,023, which feature an overload breaker attached to the center electrode of the surge diverter. A fusible element and a varistor are clamped between a spring arm of the overload breaker and an outer electrode of the surge diverter, in each instance. After assembly of the surge diverter, the spring, the fusible element and the varistor, the surge diverter is incorporated in the respective applications, e.g., into a printed circuit board.

The fusible element serves here as a safety fuse to protect the surge diverter from overheating in case of an error. The known surge diverter has the disadvantage that, while the safety fuse actually does prevent the surge diverter from overheating and therefore effectively prevents fires, there is the risk that the heat energy needed for melting the safety fuse is sufficient to melt the solder that holds the diverter to the printed circuit board and thereby unsolder the diverter.

To solve this problem, it would be necessary to install safety fuses having a very low melting temperature in the surge diverter. However, this is not possible with known surge diverters because safety fuses having a very low melting temperature are not able to withstand the soldering process of the surge diverter onto the printed circuit board.

It is the purpose of the present invention to provide a spring clip for use in a surge diverter that makes it possible to use fusible elements having a low melting temperature. It is a further purpose of the invention to provide a surge diverter array in which the surge diverter is prevented from being unsoldered quickly. It is another purpose of the invention to provide a method for manufacturing such an array.

These purposes are achieved by means of a spring clip according to claim 1, by a surge diverter array according to claim 12 and claim 13, as well as by a method for manufacturing the array according to claim 16. Advantageous embodiments of the spring clip and the surge diverter array are revealed in the subsequent patent claims.

A spring clip that has a clamping device is provided. With this clamping device the spring clip can be clamped onto a surge diverter. Also, the spring clip has at least one spring arm. Furthermore, the spring clip has a thermal protective device attached to the inside of the spring arm. The protective device also contains a fusible element.

An advantage is also the pre-assembly of the spring clip and the protective device before any thermal overload. In this way, it is possible to mount the spring clip including the protective device after the surge diverter has been soldered onto the printed circuit board. The assembly can proceed from one side of the surge diverter, e.g., on the side of the surge diverter facing away from the printed circuit board.

Since the surge diverter is therefore already firmly soldered in place at the time of assembly, and since the temperatures are therefore not high enough to melt the solder used in attaching the surge diverter, materials with a very low melting temperature can be used for the fusible element. The risk that the surge diverter with the spring clip is unsoldered is thus greatly diminished.

It is for example possible to use a fusible element whose melting temperature is below 210° C. Such a fusible element has the advantage that its melting temperature is below a temperature between 210 and 280° C. normally used in surge bath soldering and reflow soldering. This guarantees a high level of protection by triggering the thermal protective device already at relatively low temperatures.

The thermal protective device may also contain an insulating element, which is an insulator at the operating voltage of the surge diverter. It forms an electrical series connection together with the spring arm and the fusible element.

The insulating element has the effect that, under normal operating conditions, no electrical current can flow via the spring clip between two electrodes of the surge diverter, making the spring clip and the spring arm electrically ineffective under normal operating conditions.

The spring arm may also feature a contact element that extends from the spring arm toward the inside, and whose length is greater than the thickness of the insulating element.

This gives the advantage that a reliable contact can be established between the spring arm of the spring clip and an outer electrode of the surge diverter when the fusible element melts.

One spring arm may feature a grasping element for grasping the spring arm.

This results in the advantage that the spring arm can be pressed outward when the spring clip is clamped onto the surge diverter, making it easier to clamp on the spring clip.

In particular, for use in a three-electrode diverter, it is possible to arrange two opposing spring arms on one spring base and to place two opposing spring legs for clamping the spring clip onto a surge diverter at the spring base between the spring arms.

Such a spring clip has the advantage that the function of clamping the spring clip onto the surge diverter and the function of the spring arms are separated from one another within the context of the thermal protective device. This guarantees a higher operating safety. Besides, the spring clip can easily be clamped onto the center electrode of a three-electrode diverter, ensuring at the same time the necessary electrical contact between the spring arms and the center electrode of the surge diverter.

The protective device may also be attached to the spring arm by means of an attachment element.

This results in the advantage that the protective device itself can be made available in the form of a specially pre-assembled module that can be attached to the spring clip simply and inexpensively by means of a special attachment element.

In another embodiment, the protective device can be attached to the spring arm using solder, glue or rivets.

An electrically conductive glue is particularly well suited for gluing, while soft solder whose melting temperature is lower than the melting temperature of the fusible element is suitable for soldering. This provides the advantage that the fusible element no longer melts when the protective device is soldered to the spring clip and thus maintains its outer shape.

The melting temperature of such soft solder may, e.g., be 130° C. Preferably the melting temperature of the fusible element is about 200° C.

The insulating element may be attached to the fusible element through soldering. Here, a solder whose melting temperature is lower than the melting temperature of the fusible element is preferred.

The insulating element may, for example, consist of a plastic molded part. However, it is also possible to use a varistor as an insulating element, in particular so as to achieve a precision protection function on the surge diverter. The only thing that needs watching is to ensure that the varistor acts as a variable resistor at the operating voltage of the surge diverter. It is also possible to provide two opposing spring arms on a spring clip at a common spring base and to attach a protective device on the inside of each spring arm.

Such a spring clip has the advantage that it is particularly well suited for the use in three-electrode surge diverters.

Also described is a surge diverter array, with a spring clip according to above description, aside from a surge diverter having at least one outer electrode. The surge diverter is soldered onto a printed circuit board. The spring clip is clamped onto the surge diverter. A spring arm presses a thermal protective device against one outer electrode of the surge diverter.

Such a surge diverter array has the advantage that a fusible element having a very low melting temperature can be used for the protective device because it is possible, due to the spring clip, to mount the protective device onto the surge diverter at a later stage.

Another surge diverter array is described in which the surge diverter has two outer electrodes. The surge diverter also has a spring clip as described above and as is suitable for a three-electrode surge diverter. The surge diverter is soldered onto a printed circuit board. The spring clip features two opposing spring arms. Each spring arm presses a protective device against the outer electrode of the surge diverter.

Furthermore, another surge diverter array is provided, in which the surge diverter is soldered onto the printed circuit board with a solder whose melting temperature is higher than the melting temperature of the fusible element.

Also described is a method for manufacturing a surge diverter array whereby, in a first step, the surge diverter is soldered onto a printed circuit board. In a subsequent step, the spring clip is clamped onto the surge diverter.

This method has the advantage that for the fusible element of the spring clip, a fusible element with a low melting temperature may be used because clamping the spring clip and thus mounting the fusible element on the surge diverter takes place only after the surge diverter is soldered onto the printed circuit board.

In the following, the invention will be illustrated using exemplary embodiments and the respective drawings.

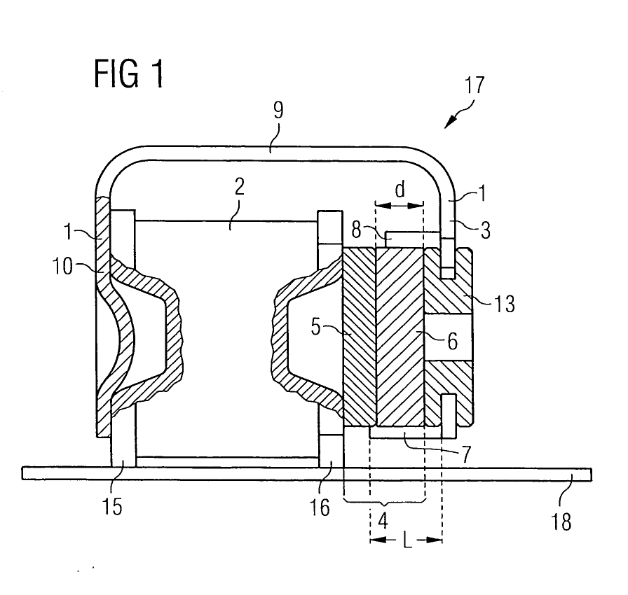

FIG. 1 shows an example of a surge diverter array in a schematic cross section.

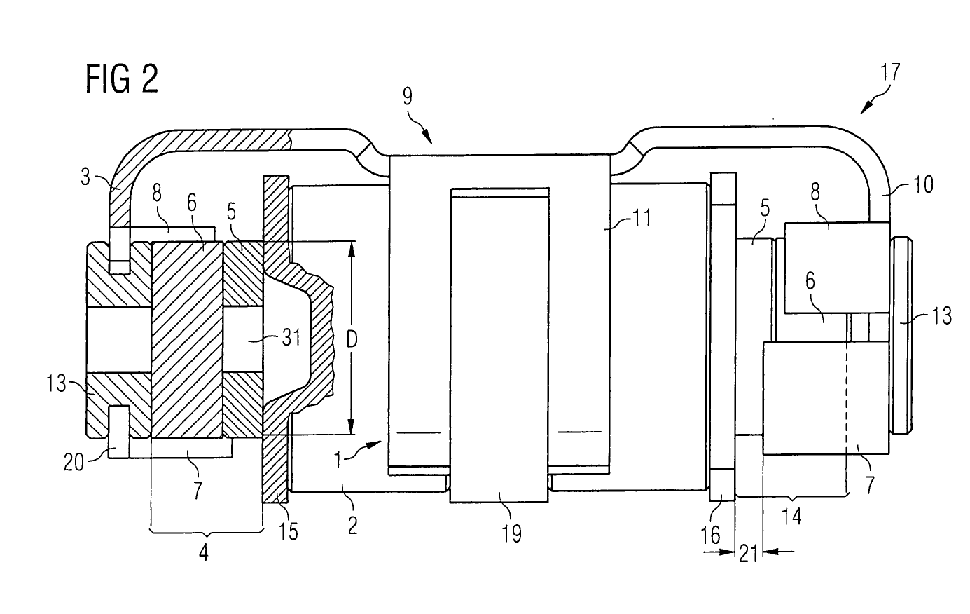

FIG. 2 shows an example of a spring clip with a surge diverter in a schematic cross section.

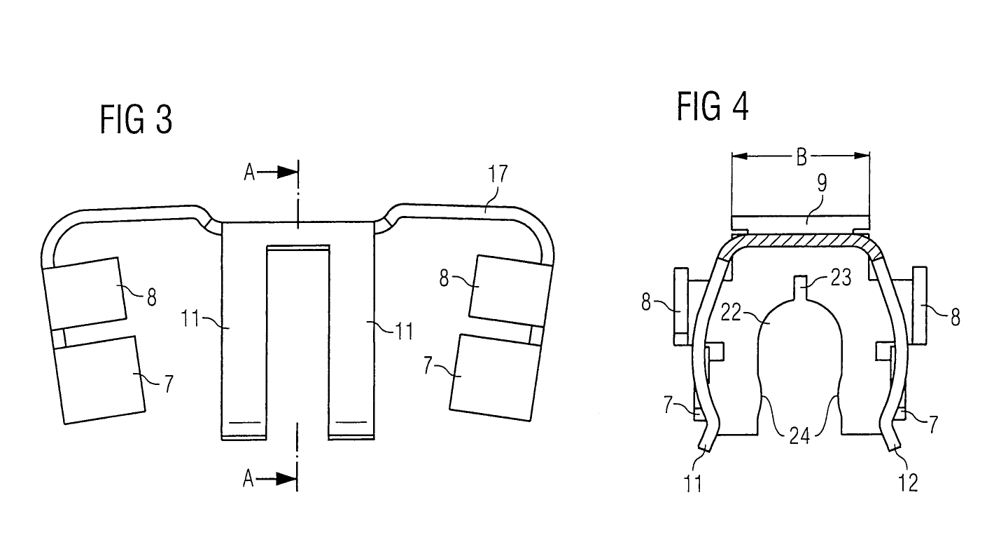

FIG. 3 shows the spring clip from FIG. 2 with a clamping device and with two spring arms.

FIG. 4 shows the spring clip from FIG. 3 in the A-A section.

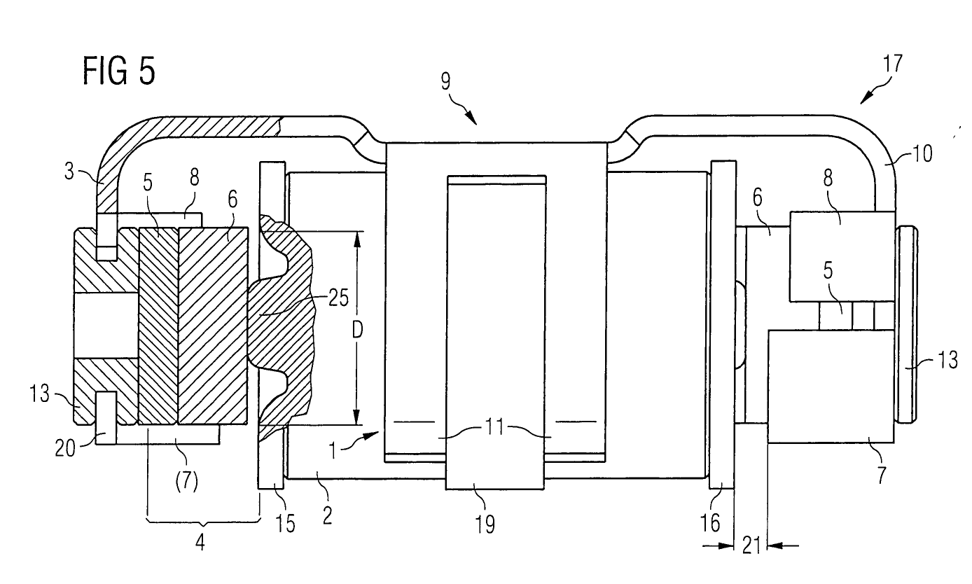

FIG. 5, 6, 7 and 8 show examples of other spring clips with surge diverters, each in schematic cross section.

In all figures, identical references refer to elements that correspond to each other.

FIG. 1 shows a two-electrode surge diverter 2 attached to a printed circuit board 18. The attachment is effected via the outer electrodes 15, 16 that are soldered onto the printed circuit board 18. One of the outer electrodes 16 features a flat edge in order to keep the surge diverter 2 from rolling away during soldering. There is also a spring clip 17 having a first spring arm 3 and another spring arm 10. Both spring arms 3, 10 form the clamping device 1 by means of which the spring clip 17 is mounted onto the surge diverter 2. A thermal protective device 4 is attached to the spring arm 3 via an attachment element 13. The thermal protective device 4 has a fusible element 5 and an insulating element 6. The fusible element 5 and the insulating element 6 are soldered to one another. The thermal protective device 4 and the attachment element 13 are also soldered to one another. The attachment element 13 is slipped onto the spring arm (see also FIG. 2). A contact element 7 is provided, whose length L is greater than the thickness d of the insulating element 6. This ensures that when the fusible element 5 melts, an electrical contact between the spring arm 3 and the outer electrode 16 can be established via the contact element 7. A grasping element 8 that can be grasped with a tool is also provided, serving to spread apart the spring arms 3, 10 when installing the surge diverter 2.

FIG. 2 shows a surge diverter 2 with the outer electrodes 15, 16. A center electrode 19 is also provided. A spring clip 17 has a spring base 9. A first spring leg 11, which is configured in two parts and which is clamped onto the center part of the surge diverter 2, is located on the spring base 9. Furthermore, spring arms 3, 10 are provided, each of which presses a thermal protective device 4, 14 against the respective outer electrodes 15, 16. The thermal protective devices 4 each consist of a fusible element 5 and an insulating element 6. The insulating element 6 may be a varistor or also a plastic molded part. The attachment element 13 consists of a conductive, metallic material, preferably brass. The attachment element 13 features an all-around recess 20 that serves to attach the spring arm 3, 10 in an assembly slit 22 (see FIG. 4).

The attachment element 13 may be made of tubing but also of solid material. In order to improve the soldering capacity, both the insulating element 6, which may be a varistor, and the attachment element 13 may have a galvanic coating. Preferably, the insulating element 6 executed as a varistor is also silver-plated. The attachment element 13 is preferably tin-plated or coated with a tin alloy. The insulating element 6 and/or the fusible element may be provided with a bore 31 to capture any excess soft solder.

In a first step, the attachment element 13, the insulating element 6, and the fusible element 5 are soldered together. The fusible element 5 is thereby executed as a soft solder disk. Soldering is done using a soft solder whose melting temperature is preferably 130° C. and, in any case, is less than the melting temperature of fusible element 5. The melting temperature of the fusible element 5 is preferably between 190 and 198° C. and should be chosen, at any rate, in such a way that during an overload the short circuit triggered by the spring clip is triggered well before the surge diverter 2 unsolders from the printed circuit board. The attachment element 13, the insulating element 6, and the fusible element 5 are in an electrical series connection.

The insulating element 6 is located between the attachment element 13 and the fusible element 5. However, it is possible to choose another sequence for the fusible element 5 and the insulating element 6. In the present case, the fusible element 5 is in contact with the outer electrode 15, 16. The outer electrode 15 may have either no contact knob, as shown in FIG. 2, or an additional contact knob 25, as shown in FIG. 5.

The pre-soldered module with the attachment element 13, insulating element 6, and fusible element 5 are then mounted in an assembly slit 22 of the spring arm 3, using the attachment element 13 (see FIG. 4). The spring clip 17 consists of a spring material, preferably copper beryllium. In order to achieve small transition and contact resistances and for a better soldering capacity it is advantageous if the spring clip 17 has a galvanic coating, preferably made of tin or a tin alloy. According to FIG. 4, the assembly slit 22 has one or two protrusions 24 meant to prevent the attachment element 13 from sliding off. Spreading open the spring arm 3 can also be aided by a slit 23. The attachment element 13 features a recess 20 all around, by means of which it can be attached to the assembly slit 22.

After attaching the attachment element 13 and after soldering the surge diverter 2 to a printed circuit board, the spring clip 17 can be grasped at the grasping elements 8 using a simple tool, and spread open. The grasping elements 8 have the advantage that both the insulating element 6 and the fusible element 5 are mechanically protected during the installation of the spring clip 17 on the already soldered surge diverter 2. However, it is also conceivable to execute all the exemplary embodiments without the grasping element 8.

After spreading apart the spring clip 17, it is clamped onto the center section of the surge diverter 2 with the spring legs 11, 12 (see also FIG. 4) by sliding one side of the diverter 2 over it. In the process, the center electrode 19 of the surge diverter 2 can serve as guide and electrical contact element. For this purpose the center electrode 19 is introduced into the slit located between the two parts of the spring legs 11, 12. The outside diameter of the outer electrodes 15, 16 is equal to or somewhat greater than the diameter of the directly adjoining part of the surge diverter 2. This ensures easy soldering onto the printed circuit board by way of surge bath soldering or reflow soldering. The lo outer electrodes 15, 16 may be round or square. A square design of the outer electrodes 15, 16 prevents that the surge diverter 2 from rolling away from the printed circuit board.

The geometrical dimensions of the contact element 7 and the protective device 4, 14 are chosen in such a way that a sufficient air fissure 21 remains between contact element 7 and outer electrode 15, 16. FIG. 2 also shows that the spring legs 11, 12 do not protrude beyond the outer dimensions of the surge diverter 2. This is the only way to safely clamp the spring clip 17 onto a printed circuit board even after soldering the surge diverter 2 in place.

The electrical and mechanical attachment of the spring arms 3, 10 to the center electrode 19 takes place via the spring base 9.

FIG. 3 shows the spring clip 17 from FIG. 2 with the grasping elements 8 as well as the contact elements 7.

FIG. 4 shows the spring clip 17 from FIG. 2. The width B of the spring base 9 is somewhat larger than the diameter D of the thermal protective device 4. This mechanically protects the thermal protective device 4 during the assembly process (see also FIG. 2).

FIG. 5 shows a spring clip 17 with a surge diverter 2 according to FIG. 2, however with the outer electrodes 15, 16 being provided with a contact knob 25. The contact knob 25 preferably protrudes by a few tenths of a millimeter beyond the exterior surface of the outer electrodes 15, 16. By means of the spring force of the spring arms 3, 10, which is transmitted to the contact knob 25 via the fusible element 5 and the insulating element 6, a high contact force is created that is generated continuously and that ensures the reliable transmission of high electrical currents. A planar or also a convex outer electrode 15, 16 may be used. The planar or convex contour may be interrupted by a depression.

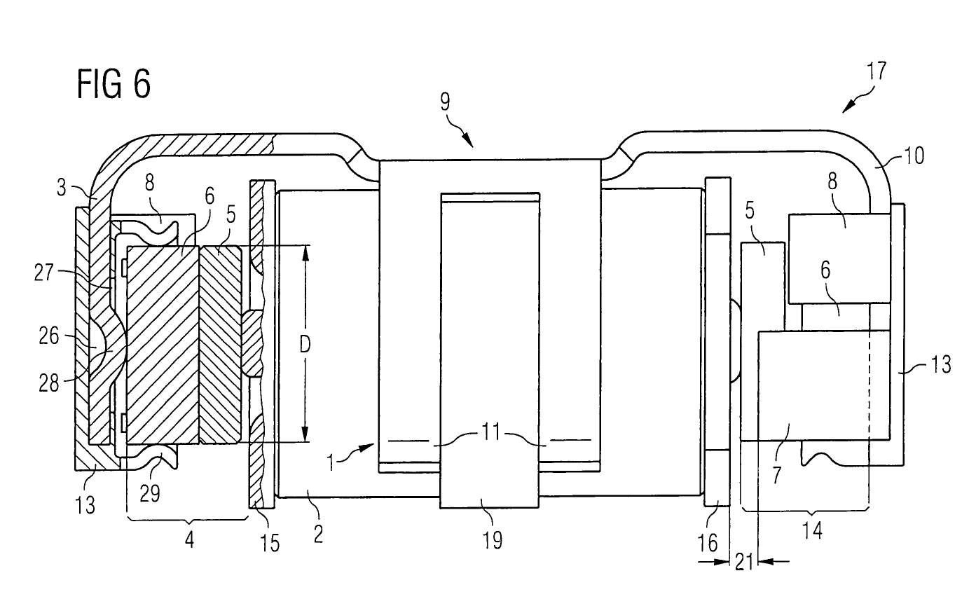

FIG. 6 shows a spring clip 17 with a surge diverter 2 according to FIG. 2. What is different from FIG. 2, however, is that the attachment element 13 is a plastic molded part featuring a recess 26. With the help of this recess 26 the attachment element 13 can be slipped over the spring arm 3, 10. The attachment element 13 also has a spring element 29 into which the thermal protective device 4, 14 is inserted. The attachment element 13 also has a hole 27 which a contact knob 28 of the spring arm 3, 10 hooks into and which serves to secure the attachment of the attachment element 13 on the spring arm 3, 10. According to FIG. 6, the insulating element 6 is inserted into the attachment element 13.

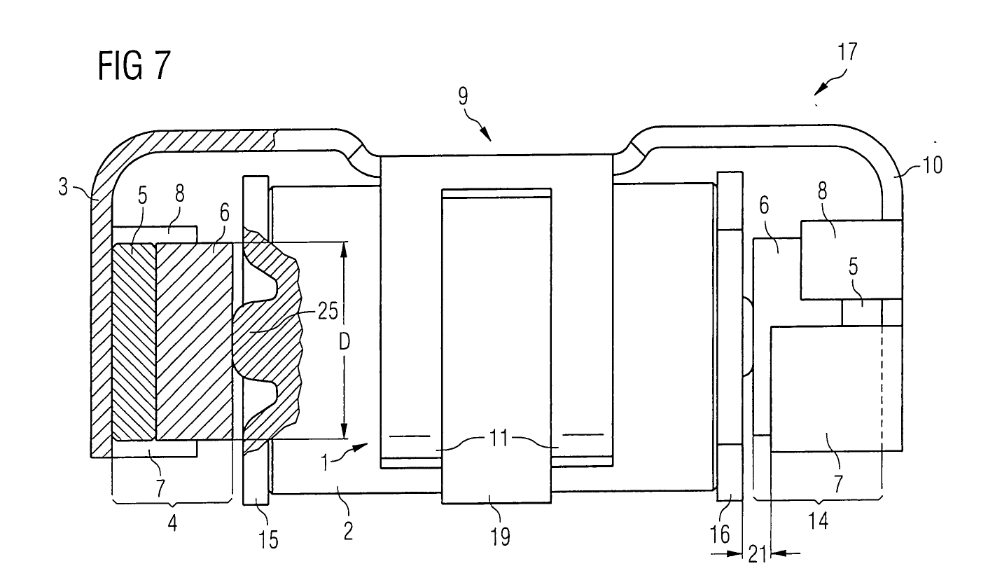

FIG. 7 shows a spring clip 17 with a surge diverter 2 according to FIG. 2. Contrary to FIG. 2, no attachment element 13 is provided. Rather, the spring arm 3, 10, the fusible element 5 and the insulating element 6 are directly soldered together. A solder with a low melting temperature of preferably about 130° C. is used for soldering. It is possible to switch the position of the fusible element 5 and the insulating element 6.

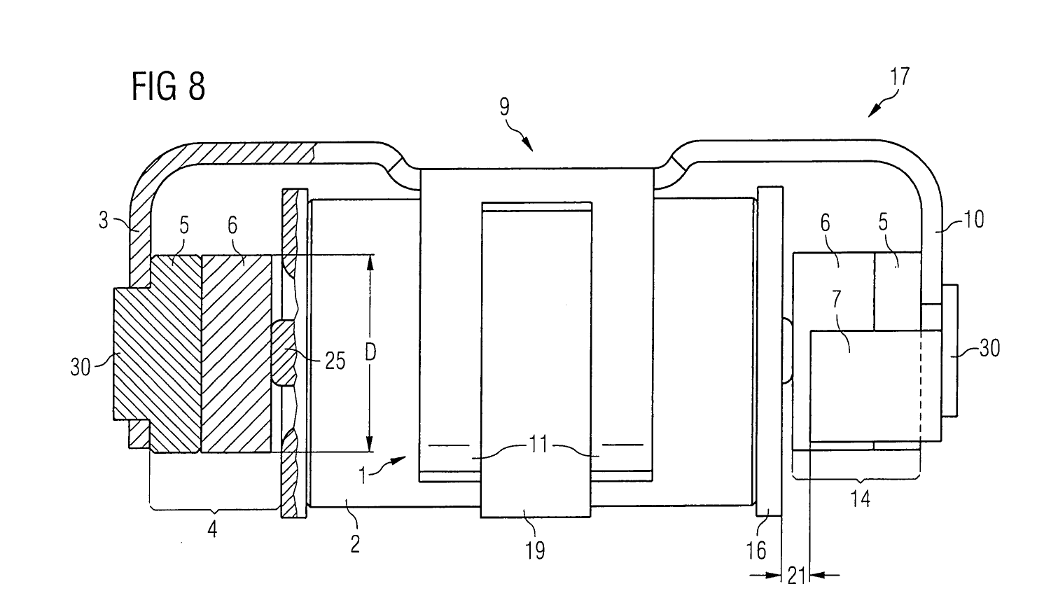

FIG. 8 does not use an attachment element 13, either. Rather, the fusible element 5 is executed as a molded part with a protruding projection 30. This projection 30 fits into a hole in the spring arm 3, 10 to which it can be riveted. FIG. 8 also lacks the grasping elements 8. Rather, only the contact elements 7 are provided. The contact elements 7 may, however, also be used as grasping elements.

In other exemplary embodiments, the described soft soldering may be replaced by gluing, using a conductive glue such as a silver glue, for example.

In another exemplary embodiment, the precision protective function of the surge diverter may be dispensed with and the insulating element 6 can thus be executed not as a varistor but as a simple insulator, for example a plastic disk. This plastic disk can be glued to the fusible element 5 with glue. However, the plastic disk may also be glued directly to the spring arm 3. The plastic disk may have layers at the circular surfaces that can be soldered, which makes it possible to use soft solder for the thermal protective device 4, 14. Replacing the varistor by a simple insulator as the insulating element 6 has the advantage that the same spring clip 17 can be used for both embodiments, with and without precision protective function of the surge diverter, without the need for any other components/modifications.

In a further embodiment, both the insulating element 6 and the fusible element 5 may be made of plastic.

The present invention is not limited to three-electrode surge diverters but may be used for any diverter whatsoever.

1. An apparatus for use with a surge protector, the apparatus comprising:
a clamping device that attaches to the surge protector, the clamping device comprising a spring arm; and
a protective device attached to an inside of the spring arm that faces the surge protector, the protective device comprising a fusible element that melts when heat above a predefined temperature is applied.

2. The apparatus of claim 1, wherein the predefined temperature is less than 210° C.

3. The apparatus of claim 1, wherein the protective device further comprises:
an insulating element that acts as an insulator at an operating voltage of the surge protector, and that is connected in series with the spring arm and the fusible element.

4. The apparatus of claim 3, wherein the spring arm comprises a contact element that extends toward the fusible element and that has a length that is greater than a thickness of the insulating element.

5. The apparatus of claim 1, wherein the spring arm comprises a grasping element that can be grasped with a tool to spread the spring arm.

6. The apparatus of claim 1, further comprising:
a spring base and an opposing spring arm, the spring arm and the opposing spring arm being attached to the spring base; and
two spring legs that oppose each other and that are at the spring base between the spring arm and the opposing spring arm.

7. The apparatus of claim 1, wherein the protective device is attached to the spring arm via an attachment element.

8. The apparatus of claim 1, wherein the protective device is attached to the spring arm using solder, glue or rivets.

9. The apparatus of claim 3, wherein the insulating element is soldered to the fusible element using solder that has a melting temperature that is below a melting temperature of the fusible element.

10. The apparatus of claim 3, wherein the insulating element comprises a varistor.

11. The apparatus of claim 1, further comprising:
a second spring arm that opposes the spring arm;
a spring base that accommodates the spring arm and the second spring arm; and
a second protective device attached to an inside of the second spring arm that faces the surge protector, the second protective device comprising a second fusible element that melts when heat above a predefined temperature is applied.

12. The apparatus of claim 3, wherein at least one of the fusible element and the insulating element has a borehole.

13. An apparatus comprising:
a circuit board;
a surge protector attached to the circuit board, the surge protector having at least one electrode; and
an apparatus comprising:
a clamping device comprising a spring arm for attaching to the surge protector; and
a protective device attached to an inside of the spring arm that faces the surge protector, the protective device comprising a fusible element that melts when heat above a predefined temperature is applied, the clamping device attaching the protective device to the at least one electrode.

14. An apparatus comprising:
a circuit board;
a surge protector attached to the circuit board, the surge protector comprising a first electrode and a second electrode; and
an apparatus comprising:
a clamping device comprising a first spring arm and a second spring arm that opposes the first spring arm, the first and second spring arms for attaching to the surge protector;
a first protective device attached to an inside of the first spring arm that faces the surge protector, the first protective device comprising a first fusible element that melts when heat above a predefined temperature is applied;
a second protective device attached to an inside of the second spring arm that faces the surge protector, the second protective device comprising a second fusible element that melts when heat above a predefined temperature is applied; and
a spring base that accommodates the first spring arm and the second spring arm, the first spring arm connecting the first protective device to the first electrode, and the second spring arm connecting the second protective device to the second electrode.

15. The apparatus of claim 13, wherein the surge protector is soldered onto the circuit board using solder that has a melting temperature that is higher than a melting temperature of the fusible element.

16. A method of manufacturing a surge protector, the method comprising:
soldering a surge protector to a circuit board, the surge protector having at least one electrode; and
clamping an apparatus onto the surge protector, the apparatus comprising:
a clamping device comprising a spring arm for attaching to the surge protector; and
a protective device attached to an inside of the spring arm that faces the surge protector, the protective device comprising a fusible element that melts when heat above a predefined temperature is applied, the clamping device attaching the protective device to the at least one electrode.

17. The apparatus of claim 14, wherein the surge protector is soldered onto the circuit board using solder that has a melting temperature that is higher than a melting temperature of the first fusible element and that is higher than a melting temperature of the second fusible element.

18. A method of manufacturing a surge protector, the method comprising:
soldering a surge protector to a circuit board, the surge protector comprising a first electrode and a second electrode; and
clamping an apparatus to the surge protector, the apparatus comprising:
a clamping device comprising a first spring arm and a second spring arm that opposes the first spring arm, the first and second spring arms for attaching to the surge protector;
a first protective device attached to an inside of the first spring arm that faces the surge protector, the first protective device comprising a first fusible element that melts when heat above a predefined temperature is applied;
a second protective device attached to an inside of the second spring arm that faces the surge protector, the second protective device comprising a second fusible element that melts when heat above a predefined temperature is applied; and
a spring base that accommodates the first spring arm and the second spring arm, the first spring arm connecting the first protective device to the first electrode, and the second spring arm connecting the second protective device to the second electrode.
